(19) United States
(12) Patent Application Publication
(10) Pub. No.: US 2019/0072485 A1
(43) Pub. Date: Mar. 7, 2019

(54) SYSTEM AND METHOD FOR MONITORING REAGENT CONCENTRATIONS

(71) Applicant: Ventana Medical Systems, Inc., Tucson, AZ (US)

(72) Inventors: Emily S. Alkandry, Rockville, MD (US); Collin Gilchrist, Tucson, AZ (US); Jamie L. Hernandez, Tucson, AZ (US); Shawn M. Iles, Tucson, AZ (US); Lisa A. Jones, Tucson, AZ (US); Raymond T. Kozikowski, III, Tucson, AZ (US); Pete Moya, Tucson, AZ (US); Tyler Toth, Prescott, AZ (US); Danton Whittier, Tucson, AZ (US)

(21) Appl. No.: 16/179,770

(22) Filed: Nov. 2, 2018

Related U.S. Application Data
(63) Continuation of application No. PCT/EP2017/060387, filed on May 2, 2017.
(60) Provisional application No. 62/331,198, filed on May 3, 2016.

(51) Int. Cl. G01N 21/552; G01N 21/41; G01N 21/43; G01N 1/31

(52) U.S. Cl. CPC G01N 21/552; G01N 21/4133; G01N 21/43; G01N 2021/1731; G01N 2201/0612; G01N 2201/025; G01N 2201/0639; G01N 1/312

(57) ABSTRACT

The present invention relates to a system and method for monitoring changes in reagent concentration, and in particular, to a system and method for monitoring for changes in reagent concentrations within small volumes of liquids in contact with a biological sample disposed on a substrate such as a microscope slide. The disclosed system and method utilize changes in electromagnetic properties associated with an interface between the substrate and a liquid applied to the biological sample in order to provide information regarding changes in reagent concentration within the liquid.

### RELATED APPLICATION DATA

This is a continuation of PCT/EP2017/060387, filed May 2, 2017, and claims priority to and the benefit of U.S. Provisional Patent Application No. 62/331,198, filed May 3, 2016, the contents of which prior applications are incorporated by reference herein.

### FIELD

The present invention relates to a system and method for monitoring changes in reagent concentration, and in particular, to a system and method for monitoring for changes in reagent concentrations within small volumes of liquids in contact with a biological sample disposed on a substrate such as a microscope slide.

### BACKGROUND

Tissue- and cell-based diagnostics typically involve staining a biological sample for various biological structures and/or markers to determine a disease state of the sample. Staining enhances the image seen by a pathologist (for example, through a microscope) by coloring certain parts of a tissue sample and not others in order to provide contrast between structures of differing types. Number, location, and/or distribution information for particular molecular entities within the sample are also available in some assay types. Automation seeks to improve the quality of the staining process by maintaining a more reliable and consistent staining environment. The staining process typically includes steps where solutions are contacted to samples mounted on a substrate, such as a microscope slide.

During the staining process, the sample is contacted with a series of pre-determined liquid reagents for pre-determined lengths of time, with each liquid reagent generally having particular concentrations of components. However, the concentration of components within these solutions can change over time due to evaporation of the solvent or depletion of reagent components caused by reactions and interactions taking place on the molecular level within a volume of the liquid reagent. For example, the concentration of a buffer solution can increase over time as a solvent evaporates, which can happen more readily when heating of the sample is employed in a particular protocol. Since concentrations can affect the reactions and interactions taking place between the liquid reagent and the sample, it would be desirable to have a way to monitor changes within the liquid reagent as it reacts/interacts with the sample. In particular, a way to monitor reagent concentrations during sample processing, while not disrupting a delicate tissue sample, would be of benefit for controlling the staining process, either manually or automatically.

Current methods of concentration assessment lack live feedback and instead rely on mathematical models concerning evaporation to predict these changes. Providing live feedback would provide a user with the ability to control solution concentration while staining tissue samples. The art of anatomical pathology often involves personal preferences with regard to color saturation, which is often a direct product of solution concentration and staining time. Therefore, a system that provides a user with real-time information on concentration would provide real-time adjustability of staining. Furthermore, since each sample can be different, such control helps to standardize staining colors across samples, systems and laboratories, a feature that is also advantageous for digital pathology methods that depends on consistency. Additionally, real-time monitoring of the staining process could help prevent unnecessary use of reagents, which not only saves money, but can reduce hazardous waste volumes.

### SUMMARY

In an aspect, a system is disclosed for monitoring treatment of a biological sample with a fluid, wherein the biological sample is mounted on a surface of a substrate. The disclosed system includes a source of electromagnetic radiation and at least one prism positioned to receive the electromagnetic radiation from the source and direct the electromagnetic radiation to a first surface of the substrate. The first surface is opposite a second surface of the substrate where the biological sample is mounted. During treatment, fluid overlays at least a portion of the biological sample mounted on the second surface. The electromagnetic radiation leaving the prism further passes through the substrate to an interface between the substrate and the fluid where some of the light is reflected from the interface between the substrate and the fluid back into the prism. The prism directs the electromagnetic radiation that is reflected by the interface between the substrate and the fluid onto a detector. A change in a characteristic of the electromagnetic radiation indicates a change in a concentration of a component of the fluid, and a processor of the system receives a signal from the detector and converts the signal into a measure of the concentration of the component of the fluid.

In a particular embodiment, a system is disclosed for treatment of a biological sample mounted on a substrate with one or more fluids. The system of this embodiment includes at least one substrate holder, at least one source of electromagnetic radiation and at least one prism positioned to receive the electromagnetic radiation from the source and direct the electromagnetic radiation to a first surface of the substrate. The first surface is opposite a second surface and the biological sample is mounted on the second surface. During treatment, fluid overlays at least a portion of the biological sample mounted on the second surface, and the electromagnetic radiation passes through the substrate, to an interface between the substrate and the fluid. A detector is positioned to detect electromagnetic radiation reflected from the interface between the substrate and the fluid, back through the substrate and through the prism, wherein a change in a characteristic of the electromagnetic radiation reflected from the interface between the substrate and the fluid and impinging on the detector indicates a change in a concentration of a component of the fluid. The system of this embodiment further includes at least one automated fluid dispenser configured to deliver additional fluid or fluids to the substrate. Controlling the system is a processor that receives a signal from the detector and converts the signal into a measure of the concentration of the component of the fluid, and if the measure of the concentration of the component has changed more than a predetermined amount from an initial concentration, the processor directs the automated fluid dispenser to dispense either or both of the first and/or second fluid to the second surface of the substrate where the biological sample is mounted.

In another aspect, a method is disclosed for monitoring a staining process of a biological sample taking place on a substrate. The disclosed method includes, passing electromagnetic radiation through a prism to a first side of the substrate, wherein the first surface is opposite a second surface. A biological sample is mounted on the second surface and fluid overlays at least a portion of the biological sample mounted on the second surface. The electromagnetic radiation passes through the substrate and to an interface between the substrate and the fluid where at least a portion of the electromagnetic radiation is reflected from the interface between the substrate and the fluid back through the substrate, back through the prism and onto a detector. The method further includes measuring a characteristic of the light reflected from the interface between the substrate and the fluid, wherein the characteristic of the electromagnetic radiation comprises a characteristic influenced by a composition of the fluid.

### BRIEF DESCRIPTION OF THE DRAWINGS

FIG. 1 is a schematic drawing showing an embodiment of the disclosed system.

FIG. 2 is a schematic drawing showing components of a particular embodiment of the disclosed system.

FIG. 3 is a schematic drawing showing components of a controller, housing and user interface for an embodiment of the disclosed system.

FIG. 4 is a schematic drawing showing a particular embodiment of an optical coupling unit of the disclosed system that can be employed in the disclosed method.

FIG. 5 is a representation of a user interface according to a particular disclosed embodiment.

FIG. 6 is a circuit diagram for a low-cost laser LED driver.

FIGS. 7A, 7B and 7C are perspective drawings of a modified Dove prism according to a particular embodiment that can be used with the disclosed system and method.

FIG. 8 illustrates how an embodiment of the disclosed system yields detectable changes in a characteristic of electromagnetic radiation as on-substrate concentrations of fluid components change.

FIG. 9 shows how, according to a particular embodiment of the disclosed system and method, electromagnetic radiation interacts with a fluid disposed on a substrate.

FIGS. 10A, 10B, 10C and 10D show images and image analysis results obtained with a particular embodiment of the disclosed system.

FIGS. 11A, 11B, 11C and 11D are graphs of concentration versus image position for several different fluid reagents that were obtained using a particular embodiment of the disclosed system.

FIG. 12 is a 3D plot showing the dependence of image position on both fluid reagent concentration and temperature in a particular embodiment according to the disclosure.

FIG. 13 is a plot of concentration over time obtained according to a particular embodiment.

### DETAILED DESCRIPTION OF ILLUSTRATIVE EMBODIMENTS

In one embodiment, a system is disclosed for monitoring treatment of a biological sample with a fluid. The biological sample is mounted on a surface of a substrate and the system includes a source of electromagnetic radiation and at least one prism positioned to receive the electromagnetic radiation from the source and direct the electromagnetic radiation to a first surface of the substrate. The first surface is opposite a second surface on which the biological sample is mounted, and, during treatment of the sample, fluid is applied to at least a portion of the biological sample mounted on the second surface. The electromagnetic radiation passes through the substrate from the first surface to the second surface, and then further to an interface between the substrate and the fluid. At the interface, at least a portion of the electromagnetic radiation is reflected back through the substrate and through the prism to a detector position to capture this reflected electromagnetic radiation. A change in a characteristic of the electromagnetic radiation that is reflected from the interface between the substrate and the fluid and impinging on the detector indicates a change in a concentration of a component of the fluid. A processor receives a signal from the detector and converts the signal into a measure of the concentration of the component of the fluid.

According to one embodiment, the electromagnetic radiation that passes through the substrate and is reflected off of a bottom surface of the fluid at the interface between the substrate and the fluid can also pass through a portion of a biological sample between the substrate and the fluid that lies over the sample. In practice, the biological sample will affect the electromagnetic radiation to a negligible degree since the sample mounted on a substrate typically is a very thin tissue section, a layer or layers of cells, or individual molecules adhered to the surface of the substrate (such as in a protein or nucleic acid microarray). Thus, it is the interaction of the electromagnetic radiation with a bottom surface of the fluid at the interface between the substrate and the fluid that determines the detected characteristic. Thus, as used herein, the phrase “interface between the substrate and the fluid” is meant to encompass the situation where a biological sample is disposed between the substrate and the fluid. Nevertheless, in some embodiments, it may be the case that the electromagnetic radiation interacts with the fluid at a point on the substrate where no biological sample is present. Alternatively, it could be that the electromagnetic radiation that impinges on the bottom surface of the fluid passes through a biological sample on its path to the interface between the substrate and the fluid but does not pass through the biological sample on its path back through the substrate toward the detector, and, the opposite could be true that the electromagnetic radiation passes through the biological sample only on the path back through the substrate.

In a particular embodiment, the source of electromagnetic radiation can be a laser source of radiation, such as a laser LED operating for example, in the visible portion of the electromagnetic spectrum (between about 400 nm and about 700 nm) or in the near-infrared portion of the electromagnetic spectrum (between about 700 nm and about 1100 nm). In other particular embodiments, the light path of the system further includes a focusing lens positioned between the source of electromagnetic radiation and the prism. As used herein, the term “focusing” includes focusing, collimation and defocusing to provide a smaller or wider range of light paths at different angles as the electromagnetic radiation enters the prism, as is needed in a particular embodiment. In another particular embodiment the prism is a modified dove prism configured to impinge the electromagnetic radiation onto the interface between the substrate and the fluid at an angle such that at least a portion of the electromagnetic radiation is reflected by total internal reflection from the interface between the substrate and the fluid back through the prism toward the detector.

In other particular embodiments, the detector is a detector array, for example, a CMOS array. In general, a detector array includes a mosaic of spaced detector elements that convert incident electromagnetic radiation into electrical signals and a readout circuit that relays and multiplexes the electrical signal from each detector element (or pixel) to one or more output amplifiers. Other examples of detector arrays include CCD (charge coupled device) camera elements, MOFSET devices (including CMOS arrays), CID (charge injection) devices and CIM (charge imaging matrix) devices. Thus, in some embodiments, the characteristic of the electromagnetic radiation reflected from the interface between the substrate and the fluid is a 2-dimensional shape of the electromagnetic radiation reflected from the interface between the substrate and the fluid and impinging on the detector array.

In other particular embodiments, the disclosed system further includes a liquid temperature sensor for monitoring the temperature of at least a portion of the fluid. In a more particular embodiment the liquid temperature sensor includes a thermocouple in contact with the fluid and/or the prism. Alternatively, the liquid temperature sensor includes an infrared liquid temperature-sensor, such as a non-contact infrared thermometer, positioned to measure a temperature of the fluid and/or the prism.

In other embodiments, the prism is optically connected to the source of electromagnetic radiation by at least one first electromagnetic wave guide leading from the source of electromagnetic radiation toward a surface of the prism. And, likewise, the prism can be optically connected to the detector by at least one second electromagnetic wave guide leading from the prism to the detector. In particular embodiments, the first and second electromagnetic wave guides each comprise at least one optical fiber, and in even more particular embodiments, the first and second electromagnetic wave guides each comprise bundles of optical fibers.

In still other embodiments, the system further includes a prism actuator configured to move the prism relative to the first surface of the substrate in order to direct the electromagnetic radiation at least partially toward a different portion of the interface between the substrate and the fluid or to impinge the electromagnetic radiation on the first surface of the substrate at a different angle. In more particular embodiments, the prism actuator serves to impinge the electromagnetic radiation into the substrate at an angle where that at least a portion of the electromagnetic radiation is reflected from the interface between the substrate and the fluid and then directed toward the detector. In even more particular embodiments, a refractive index matching substance, such as a refractive index matching fluid, is present between the prism and the substrate.

In other embodiments, the system includes a feedback module configured to detect changes to the fluid and cause the system to adjust the composition of the fluid by causing a dispenser to dispense a second amount of the same, or a different, fluid onto the substrate in response to the detected change in the concentration of the component of the fluid. In certain embodiments, changes in a fluid composition are detected as a change in a characteristic of the electromagnetic radiation reaching the detector. The characteristic can be one or more of, in any combination, of the amount of the electromagnetic radiation that is reflected from the interface between the substrate and the fluid, a pattern of the electromagnetic radiation reflected from the interface between the substrate and the fluid, a position of the electromagnetic radiation reflected from the interface between the substrate and the fluid, and the polarization of the electromagnetic radiation that is reflected from the interface between the substrate and the fluid. When a change is detected in the characteristic, this can be converted into a change in concentration of a component of the fluid and appropriate steps can be taken to compensate for the change in concentration of the component of the fluid. For example, if an increase in component concentration (such as can happen when a solvent evaporates from a buffer solution) is detected outside of a predetermined range, additional solvent (such as water) can be added by the dispenser to replenish the solvent lost and restore the fluid to a composition within the pre-determined range. The replenishment amount can be determined by a calculation based on the detected concentration of the component(s) in the fluid, or the feedback loop can be utilized to titrate the fluid concentration repeatedly back until it lies within the predetermined range. As another example, a component of the fluid could be consumed during a detection reaction (such as a chromogen consumed by an enzyme in a detection scheme) and its concentration in the fluid could decrease. In response, an additional amount of the fluid reagent containing the component consumed could be added by the dispenser to compensate for what was lost. The dispenser used for such replenishment schemes can be any type of dispenser known or later developed, and while it is possible to manually replenish fluids and solvents, the dispenser can be under processor control. Examples of dispensers that can be computer controlled include robotic pipettors, fluid supply lines, ink-jet dispensers, syringe pumps and disposable mechanical dispensers that are actuated with a plunger or hammer.

In further embodiments, the system includes a substrate holder, wherein the substrate holder is either at least partially optically transparent to the electromagnetic radiation or supports the substrate by at least one outer edge of the substrate. The substrate holder can be made at least partially optically transparent to the electromagnetic radiation by including an optically transparent material or by including ports in the substrate holder through which the electromagnetic radiation can pass. In a particular embodiment, the substrate holder is further configured to heat and/or cool the substrate such as by incorporating a heating element or a Peltier element. In addition, the substrate holder can be configured to apply acoustic waves or vibrations to aid in mixing of the fluid on the substrate's second surface.

In particular examples, the fluid can be at least one of a buffer, a dye, and a specific-binding molecule. In more particular examples, the specific-binding molecule comprises at least one of a nucleic acid, a nucleic acid analog, an antibody, an antibody fragment, and an aptamer. The specific-binding moiety can be further conjugated to detection moieties such as haptens, enzymes, fluorescent molecules and nanoparticles.

In another embodiment, a method is disclosed for monitoring of a staining process of a biological sample taking place on a substrate. The method includes passing electromagnetic radiation through a prism to a first surface of the substrate. The first surface is opposite a second surface of the substrate, and the biological sample is mounted on the second surface. A fluid overlays at least a portion of the biological sample mounted on the second surface. The electromagnetic radiation passes through the substrate and to an interface between the substrate and the fluid, and at least a portion of the electromagnetic radiation is reflected from the interface between the substrate and the fluid back through the substrate, back through the prism, and onto a detector. The method further includes measuring a characteristic of the electromagnetic radiation reflected from the interface between the substrate and the fluid, back through the substrate, back through the prism, and onto the detector. The characteristic of the electromagnetic radiation comprises a characteristic influenced by a composition of the fluid.

In a particular embodiment, the method further includes calculating a composition of the fluid from the measured characteristic. In a more particular embodiment, the characteristic influenced by the composition of the fluid can be characteristic influences by a refractive index of the fluid. In other particular embodiments, the method further includes compensating the measured change in the characteristic of the electromagnetic radiation for a change in temperature. Alternatively, or in addition, the method can further include compensating for a composition of the substrate and/or compensating for a starting composition of the fluid.

In another particular embodiment the detector comprises a detector array and the measured characteristic of the electromagnetic radiation comprises a two dimensional pattern of the electromagnetic radiation reflected from the interface between the substrate and the fluid.

In a more particular embodiment, the method further includes applying image analysis to sharpen a linear edge of the two dimensional image, wherein the position of the linear edge is proportional to the composition of the fluid.

In still another particular embodiment, the method can further include calculating the composition of the fluid over time. In a more particular embodiment, the staining process can be stopped when a predetermined change in the characteristic of the electromagnetic radiation is reached or when the characteristic of the electromagnetic radiation has been maintained within a predetermined range for a predetermined length of time. Alternatively, or in addition, the method can further include adjusting the composition of the fluid in response to a change in the characteristic of the electromagnetic radiation reflected from the interface between the substrate and the fluid. For example, the composition of the fluid can be adjusted by either or both of adjusting the composition of the fluid comprises applying an additional amount of the fluid to the second surface of the substrate on which the biological sample is mounted and adjusting the composition of the fluid comprises applying an additional amount of a solvent of the fluid to compensate for solvent lost due to evaporation. In even more particular embodiments, the method can include alerting a user that an adjustment needs to be made to a fluid composition in order to ensure that proper staining conditions are maintained throughout the run. Alternatively, a user can be alerted after the staining procedure that a particular fluid composition was not maintained during a staining procedure, or the system can provide a display of how the fluid composition varied during a staining procedure. Information regarding the fluid composition during one or more steps of a staining procedure can serve an important quality control function.

In a particular embodiment, a system is disclosed for treatment of a biological sample mounted on a substrate with a first fluid, the system including, at least one substrate holder, at least one source of electromagnetic radiation, at least one prism positioned to receive the electromagnetic radiation from the source and direct the electromagnetic radiation to a first surface of the substrate. The first surface of the substrate is opposite a second surface of the substrate, and the biological sample is mounted on the second surface. A fluid overlays at least a portion of the biological sample mounted on the second surface and the electromagnetic radiation further passes through the substrate, to an interface between the substrate and the fluid. A detector is positioned to detect electromagnetic radiation reflected from the interface between the substrate and the fluid, back through the substrate, and through the prism. A change in a characteristic of the electromagnetic radiation reflected from the interface between the substrate and the fluid and impinging on the detector indicates a change in a concentration of a component of the fluid. The system of this embodiment further includes at least one automated fluid dispenser configured to deliver the first fluid or a second fluid to the second surface of the substrate. A processor of the system receives a signal from the detector and converts the signal into a measure of the concentration of the component of the fluid, and if the measure of the concentration of the component has changed more than a predetermined amount from an initial concentration, the processor directs the automated fluid dispenser to dispense either or both of the first and/or second fluid to the second surface of the substrate where the biological sample is mounted. In a particular embodiments, the at least one substrate comprises a glass microscope slide. In other particular embodiments, the at least one prism comprises a modified dove prism. In yet particular embodiments, the at least one source of electromagnetic radiation comprises a fiber-coupled laser diode operating in the near infrared portion of the electromagnetic spectrum. In still further particular embodiments, the characteristic of the electromagnetic radiation comprises a 2-dimensional pattern of the electromagnetic radiation reflected from the interface between the substrate and the fluid, the detector comprises a CMOS array detector, and the processor is further configured to analyze the image of the 2-dimensional pattern of the electromagnetic radiation reflected from the interface between the substrate and sharpen a linear edge of the two dimensional image. The position of the linear edge is proportional to the concentration of a component of the fluid and can be monitored to follow changes in fluid composition.

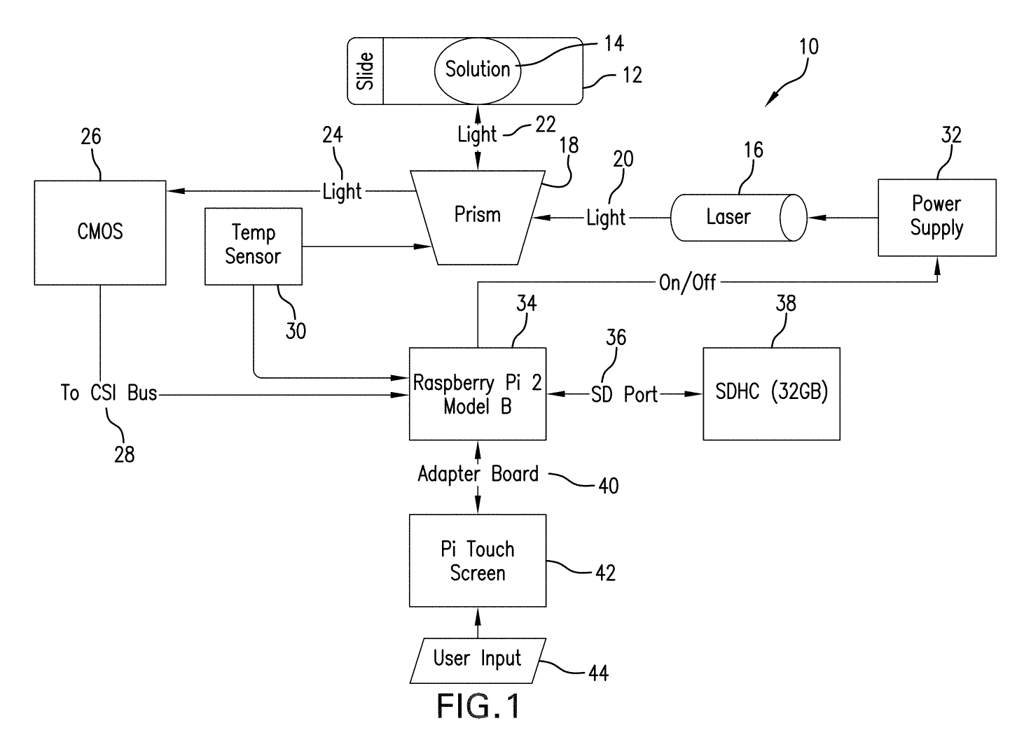

As shown in FIG. 1, a system 10 was constructed that includes a refractometer and an optical sensor to non-invasively measure the refractive index of a solution 14 covering at least a portion of a biological sample mounted on a substrate 12. From a side opposite the side on which the biological sample is placed on the substrate, electromagnetic radiation 22 (hereinafter “light”) is impinged upon the solution 14 after passing through the substrate 12. The system measured the concentration of a known solution in real-time by collecting image data periodically from the solution by capturing the reflected light that bounces off of the fluid covering a biological sample (the sample environment) with a CMOS. The light is emitted by a laser that can be active only during image capture. The light is directed through a glass prism designed to lead the light to the sample environment and guide the reflected light back to the CMOS. The image provides data that can be processed to return a concentration value to the user (or automated system) which can be recorded and/or displayed allowing visualization of the change in concentration over time. The system was designed to improve accuracy of the concentration measurement and to minimize invasiveness of obtaining the measurements. Due to the sensitive nature of processing tissue samples and the value of the human biopsy itself, it is advantageous that the device takes accurate measurements while simultaneously not damaging a specimen.

FIG. 1 also shows the overall organization of the hardware and the communication between components. Under control of the processor 34, power supply 32 can be turned on and off so that fiber-coupled laser diode 16 is only utilized as needed. Light 20 is emitted from the fiber-coupled laser diode 16 and passes through a modified Dove prism 18 before reaching the side of a microscope slide opposite a biological sample, passing through the microscope slide, perhaps passing through the biological sample, and then toward the solution in contact with the biological sample mounted on the microscope slide 12. Any reflected light 24 from the interface between the microscope slide and the solution 14 is directed by modified Dove prism 18 toward CMOS array 26, which is connected to the Raspberry Pi 34 through CSI Bus 28, and analyzed using a series of image analysis techniques. The amount of light internally reflected from the interface back through the prism depended on the ionic concentration of the buffer solution. Several variables affect the refractive index of solutions including temperature and solute concentration, and using these principles, refractive index is monitored based upon the location in space of light impinging on CMOS array 26 was developed. The system was designed around a Raspberry Pi 2 Model B single board computer (“system on a chip”) 34 functioning as the processor. By utilizing the Pi as the processor, both control and power for all auxiliary sensors (such as temperature sensor 30) and safety features could be provided. A custom written graphical user interface was designed to operate the device using input 44 from a touch screen 42 via adapter board 40. The interface enables ease of use in operating the system and provides a straight-forward method in sampling the concentration of an ionic solution. Data collected by the system can be stored in SDHC 38 in communication with the processor 34 through SD port 36.

An important capability of the Raspberry Pi is the ability to utilize a touch-screen. By connecting the screen to the DIS pins and SDA/SCL pins of the Pi, a user is able to easily interact with the system. This also allowed the implementation of a touch-based graphical user interface. The Pi allows for wired-ethernet communication, but also supports USB WiFi adapters which the design utilizes in able to remotely communicate with the Pi. The design has configured and installed with all of the prerequisites for SSH or VNC communication with the Raspberry Pi. The DIS pins and associated ribbon cable integrate with the NOIR CMOS which acts as the main sensor of the device. This is natively supported by the Pi and requires no further hardware integration other than calling raspi-config and enabling camera support. The general purpose input-output (GPIO) pins of the Pi control all of the auxiliary sensors. In particular, the GPIO pins on the Pi interface with the thermocouple to determine temperature, the lid sensor to determine the state of the lid, the relay to power on the laser, as well as the screen. The power rails of the Raspberry Pi supply current to the system fan which helps regulate the temperature of the system.

To summarize, a user can control the device through selections offered on a touch screen. When the user turns on the device, light is emitted from the laser diode and is internally reflected off the sample environment back onto a light sensitive complementary metal-oxide sensor (CMOS). The amount of light reflected onto the sensor varies with refractive index of the solution, which changes with concentration. The CMOS sensor outputs the image back to the Raspberry Pi which processes the image and determines the location of the reflected light. A model equation was used to correlate the amount of light reflected onto the sensor with the concentration of the on-slide solution. The temperature of the system will also affect the device operation, and therefore a temperature sensor is incorporated into the design. Real time data of the concentration of the solution on the slide is outputted on the touch screen and stored on an SDHD card (32 GB). In a more particular embodiment of detection of the position of the reflected light, an image of the light reflected by a bare slide was subtracted from the image of reflected light obtained with a sample loaded on a slide. Using custom coded imaging processing, the position of the reflected light was determined. Linear models relating the ionic concentration and the location of reflected light were created for four different buffer solutions and programmed into the system to allow the device to estimate the concentration over a range of 0.5× to 5× of a starting concentration for each. Testing showed that the system was successful in determining the concentration of a buffer solution within a 10% error range. Additionally, the effect of temperature on the refractive index was determined by taking measurements of solutions between 4° C. and 90° C. A model relating the location of reflected light, temperature, and concentration was developed. The device can be extended to other solutions and substrate types.

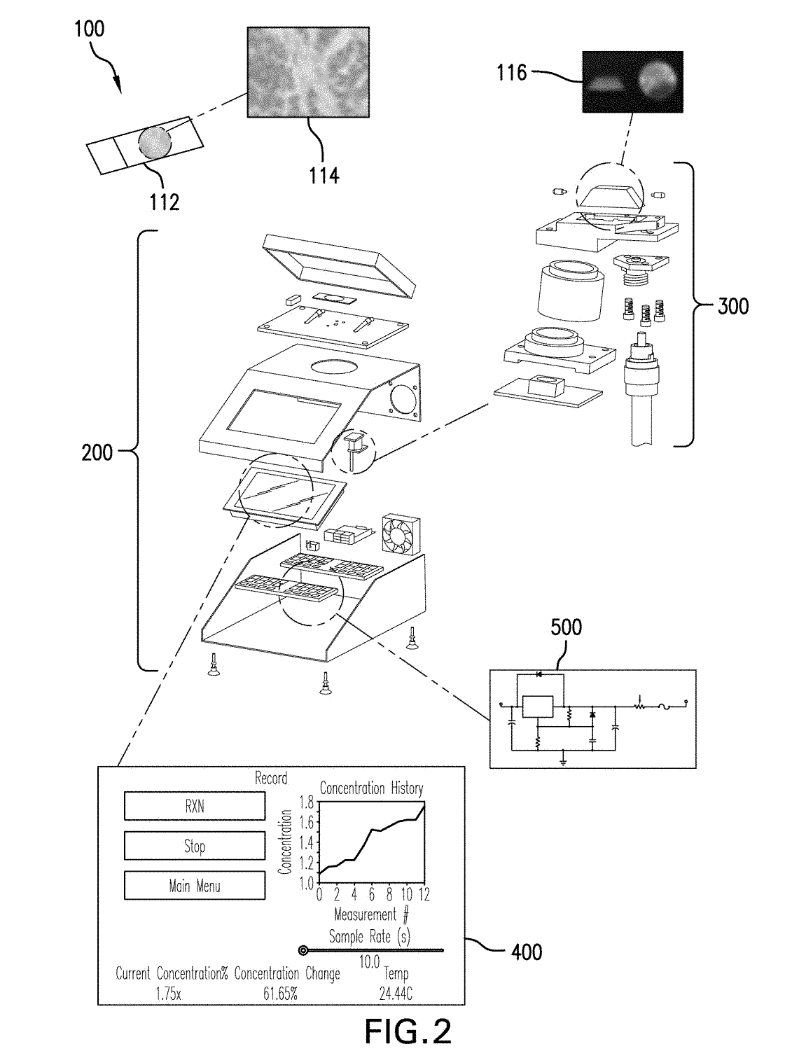

As shown in FIG. 2, the system 100 can include at least four defined subsystems: a housing 200 enclosing the hardware to control the device, a refractometer 300, an interface between the user and the system 400, and laser power circuit 500 to drive the fiber-coupled laser diode. Together, the system captures an image 116 of a sample 114 undergoing treatment with one or more fluids on substrate 112.

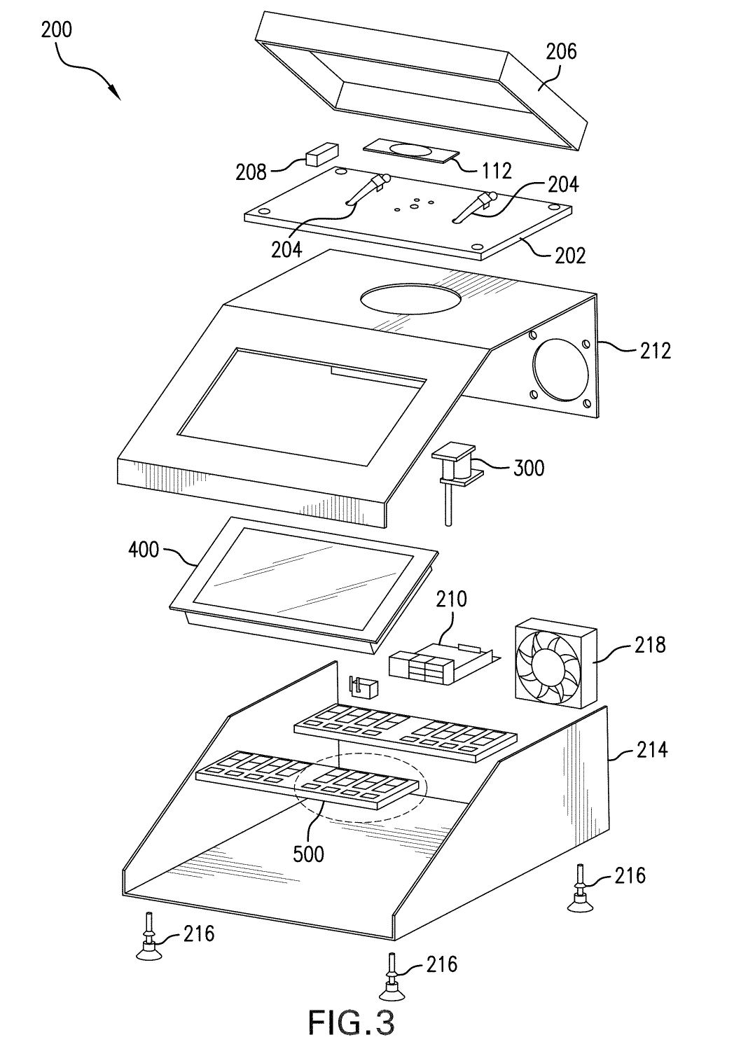

FIG. 3 shows an exploded view of the housing 200 enclosing the system hardware in more detail. Substrate 112 is held on substrate holder 202, using clips 204. Note the passages in substrate holder 202 through which light can be passed to and from refractometer subsystem 300 from below. Lid 206 was added to improve safety and magnetic switch 208 works with the processor 210 to turn off the laser diode when the lid is raised. Processor 210, additional electronics including the laser driver circuit 500, a cooling fan 218 and refractometer 300 are mounted within top cover 212 and bottom cover 214. Bottom cover 214 further includes adjustable legs 216 which can be used to ensure the entire system is level and any fluid on substrate 112 remains in place and does not flow off of the substrate. User interface 400 is mounted in top cover 212.

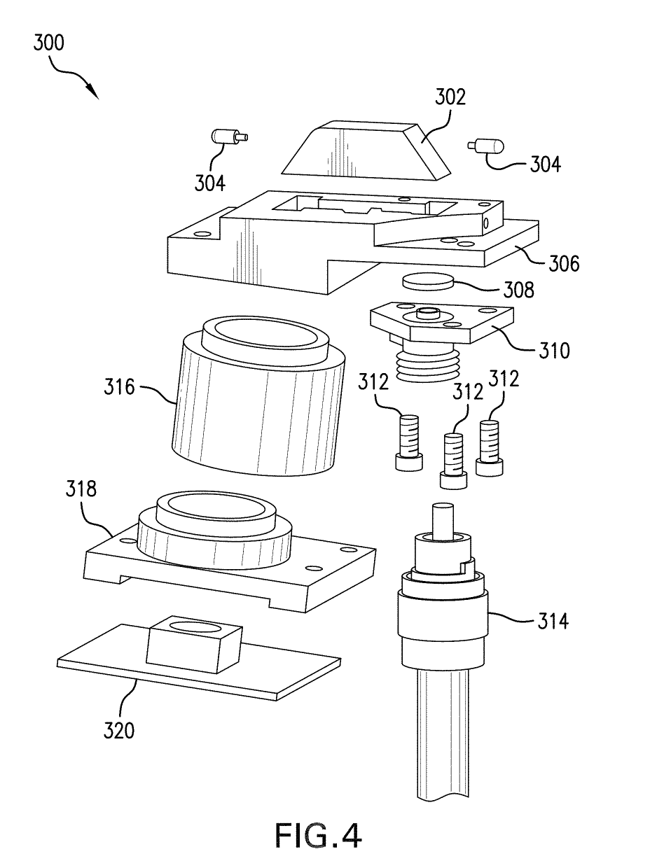

FIG. 4 shows an exploded view of the refractometer subsystem 300. A refractometer subsystem was chosen because of its simplicity of design and theoretical accuracy. The subsystem includes modified Dove prism 302, which is held in place within prism bracket 306 by set screws 304. The prism bracket holds and aligns all of the other optical components. Light from fiber-coupled laser 314, is directed toward the prism 302 through focusing lens 308, which is held in place by coupler 310 attached to the prism bracket 306 by screws 312. Lens tube and band-pass filter assembly 316 serves to direct light reflecting off of a solution on a sample toward CMOS array detector 320 held in mount 318. The geometry of the subsystem is dimensioned such that the laser light from fiber-coupled laser 314 illuminates the microscope slide/solution interface at angles that create both reflection and refraction. The reflected laser light is then intercepted by the CMOS array detector 320 and an image of the light is recorded. Both the prism and the CMOS can be shifted orthogonally from each other producing x and y alignment compensation, and the lens tube can rotate giving the final degree of freedom required to align to a plane (CMOS sensor). When no solution is on the slide, the image of the laser light does not show a boundary of total internal reflection, meaning maximal light contacts the CMOS sensor surface. When solution is added to the microscope slide, part of the light refracts which decreases the amount of light that reaches the CMOS sensor surface. The boundary between reflection and refraction can then be mapped. Any changes in the position of the boundary line between reflection and refraction corresponds to a change in the refractive index of the solution which is a material property that is indicative of concentration of components of the solution. The focusing lens installation benefited from very tight machine tolerances. To set the lens into position, it was aligned and then glued into place with UV curing optical cement. A thermocouple was epoxied to the custom prism to monitor the temperature of the prism (Adafruit Type-K thermocouple implemented in conjunction with an Adafruit MAX31855 thermocouple amplifier in order to effectively send temperature information to the Raspberry Pi).

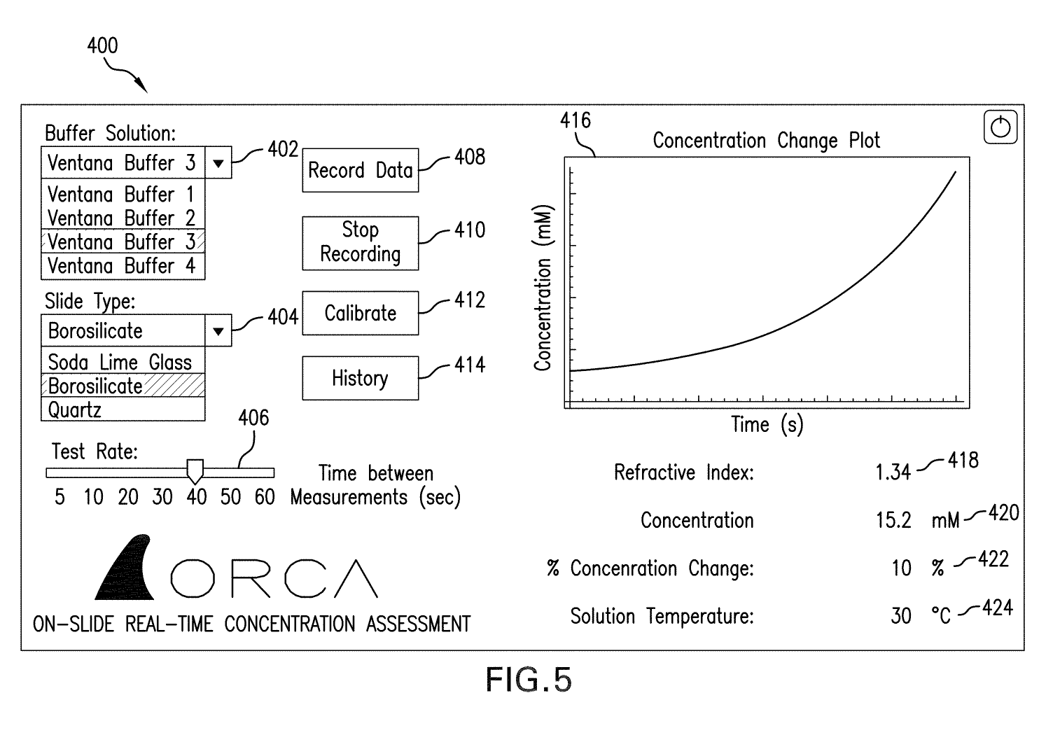

FIG. 5 shows and embodiment of the user interface 400. User interface includes elements tied to software features stored in memory of the processor. In this embodiment, user selectable pulldown menu 402 permits a user to access and utilized stored calibration curves for several different solutions. User selectable pulldown menu 404 in turn permits a user to access and utilize stored parameters for use with several different types of glass microscope slides, which have different refractive indexes. Slide element 406 permits adjustment of the sampling rate of the system. When the concentration of the solution is expected to change rapidly, a lower time between measurements can be selected, but where the concentration is not expected to change rapidly the time between measurements can be increased, thereby helping to increase the life of the laser diode because the diode is not turned on when not measurements are being made. Additional user-selectable elements 408, 410, 412, and 414, cause the system to record data, stop recording data, access a system calibration routine, and re-plot data from previous runs, respectively. Graphical display element 416 can be used to show the change in concentration of a solution over time. Numerical display elements 418, 420, 422, and 424, show a user the current measured refractive index, the current concentration, the percent change in concentration over the measurement period, and the solution temperature, respectively. A user has the ability to select the desired solution they wish to determine the concentration of in addition to selecting a sampling rate. When sampling, the system will determine the current concentration, percent the concentration has changed since the initial sample, and the temperature of the prism. The calibration screen accessed through user selectable element 412 allows the user to capture a picture of the slide. The captured slide image will automatically update the corresponding slide image for the appropriate reaction buffer. The user is then able to view how the code will process their image so that they can identify any problems in the sample, such as bubbles or uneven refractive index-matching oil placement. The illustrative GUI provides a very simple portal for users to effectively sample concentration data. The GUI also provides pop-up error messages in the event of an invalid selection.

All of the coding for the system described was done using Python 2.7. In order to communicate with the system's interfaced devices as shown in FIG. 1, perform image analysis (as further described below), and program the graphical user interface; some non-standard python packages/libraries were installed to the Raspberry Pi processor. The following libraries were installed to the Raspberry Pi processor: OpenCV2 (for image processing); Kivy (for the graphical user interface); Matplotlib (for generating graphs); Adafruit MAX31855 (for the thermocouple temperature) and Adafruit_GPIO (for determining if system lid is open). In order to make the system operate in the GUI, the python was balanced into several scripts based on their function, one for launching the GUI and calling other scripts, one for determining if the lid was open or closed, one for generating graphable data for the sample number and associated concentration, one for returning a temperature from the thermocouple, one for graphs and labels, one for taking a picture of the sample with no further processing, one to save images of each step of the processing to help debug problems, one to take a picture of the slide and orient it properly for masking, one for resizing the images so they can be displayed on the GUI, and one for plotting a graph given a data file retrieved from memory.

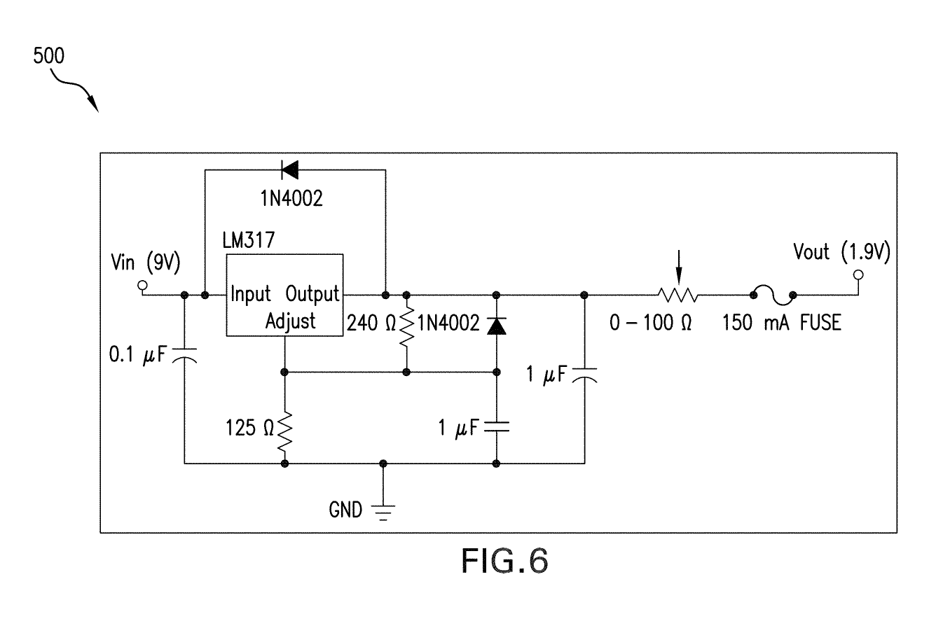

FIG. 6 shows a self-explanatory circuit diagram of laser power circuit 500 of FIG. 2 that was designed to power the 20 mW laser (780 nm) without assistance from the commercial laser driver and make the system portable and lower-cost. The voltage that the laser required was 1.9V with a current of around 30-80 mA. In order to best determine the operating current for the laser, the commercial laser driver was used to mitigate the risk of damage. By increasing the current supplied to the laser, the laser's intensity increased. After initial testing, 30 mA was determined to be an appropriate operating current for the laser. This 30 mA reduced the saturation of light in the CMOS and it helped keep the laser at a lower operating temperature.

A standard 9V wall outlet source was coupled with a voltage regulator in order to get the voltage to 1.9V. A potentiometer was placed before the laser in order to adjust the current supplied to the laser in case the intensity of the laser needed to be adjusted. Finally, a 150 mA fuse was placed in order to prevent current spikes that could potentially damage the laser.

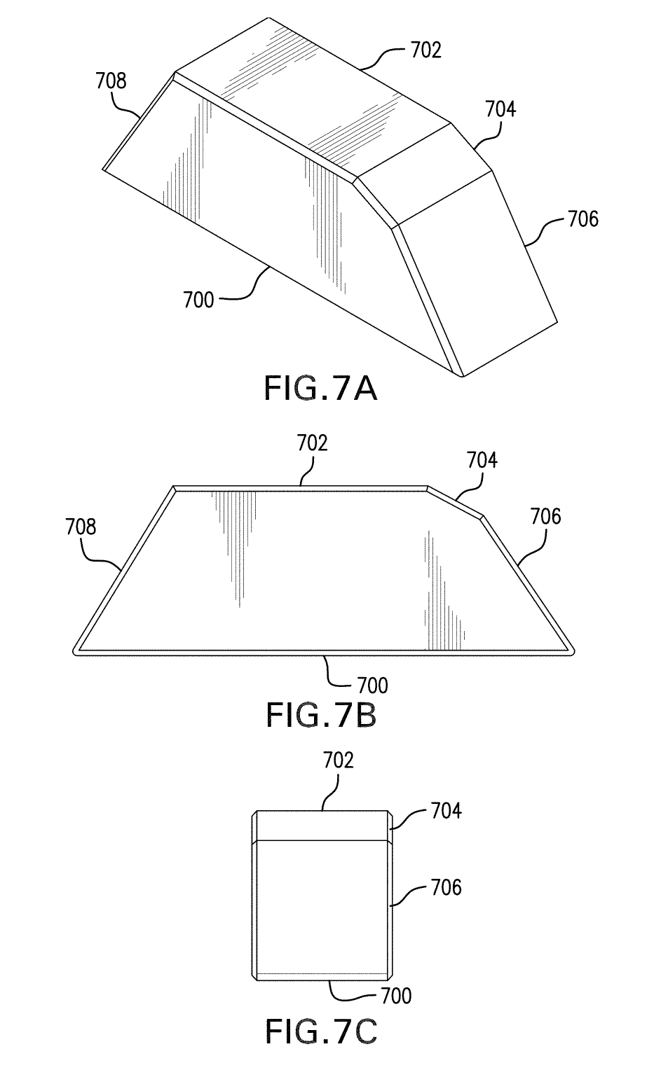

FIG. 7 shows the modified Dove prism used in the system described above in more detail. FIG. 7A shows the prism in perspective, FIG. 7B shows the prism from the side, and FIG. 7C shows the prism from one end. The faces 700, 702, 704, 706, and 708, and the angles of each relative to each other were selected according to a computer generated lens prescription that took into account the geometric orientation of each of the optical components with respect to one another. It also took into account the size of the CMOS sensor and the pixel density of the sensor. The prescription gave the glass material types of each of the components and showed how many randomly generated rays are going through the system in a non-sequential manner. The lens prescription references solid models were created in Solidworks (Dassoult Systemes S.A., Paris, France). These models were then imported into Zemax (Zemax LLC, Kirkland, Wash., USA) and had glass properties assigned to them. In a particular embodiment, faces 700 and 708 are at an angle of 58.750 degrees from each other. Face 700 and face 708 are at a 56 degree angle from each other. Face 700 and face 702 are parallel to each other, and face 702 and face 704 are at an angle of 28 degrees from each other. Only faces 700, 702, 706, and 708, must be polished.

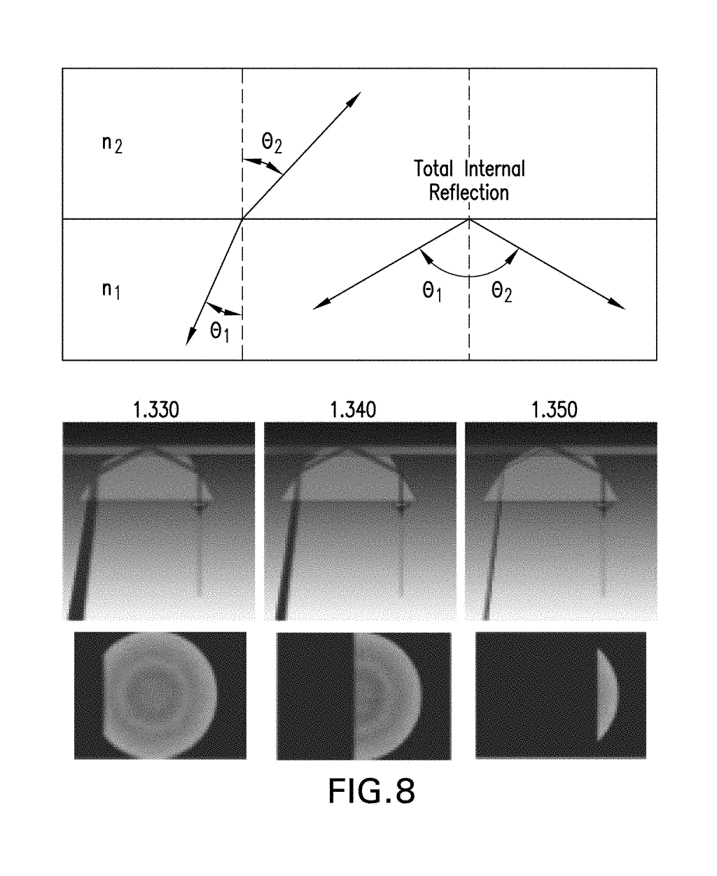

As shown in FIG. 8, some of the laser light at the solution/microscope slide interface refracts and some reflects. Reflection of the light in this manner is known total internal reflection (TIR), and it is the underlying principle that allows the refractometer to function as a sensor. Refraction is described by Snell's law (Equation 1 below) which describes the behavior of light as it propagates between two materials. This phenomenon is also known as refraction which depends on several factors such as temperature, concentration, and molecular composition.

n₁ sin θ₁=n₂ sin θ₂ Equation 1:

Examining Snell's law shows that when the sine of the angle on one side of the material interface is 90 degrees, the corresponding angle on the other side of the material interface is known as the critical angle. The critical angle is the angle where light is no longer ref racted and instead is reflected. Any light incident to the material interface at an angle greater than the critical angle will reflect instead of refracting. This reflection is known as total internal reflection (TIR). The reflected light is directed to a sensor where the boundary between reflection and refraction can be analyzed. This interface is used to determine the index of refraction of the substance being analyzed. FIG. 8 shows in the lower panels the simulated light pattern that would appear on the CMOS array in the refractometer design and how the pattern is changed depending on the change in refractive index. The leftmost panel on the bottom shows the pattern from pure water, which is the lowest concentration of solution that could be measured. As concentration increases, the refractive index is increased, and the light pattern on the array is also changed. For the non-sequential ray trace, 200,000 rays were analyzed to produce an image onto the detector. As the index of the solution increases the straight line sweeps across the CMOS array. By detecting the position of this line, the index of refraction of the fluid on the slide can be determined and the ionic concentration of the solution can be estimated.

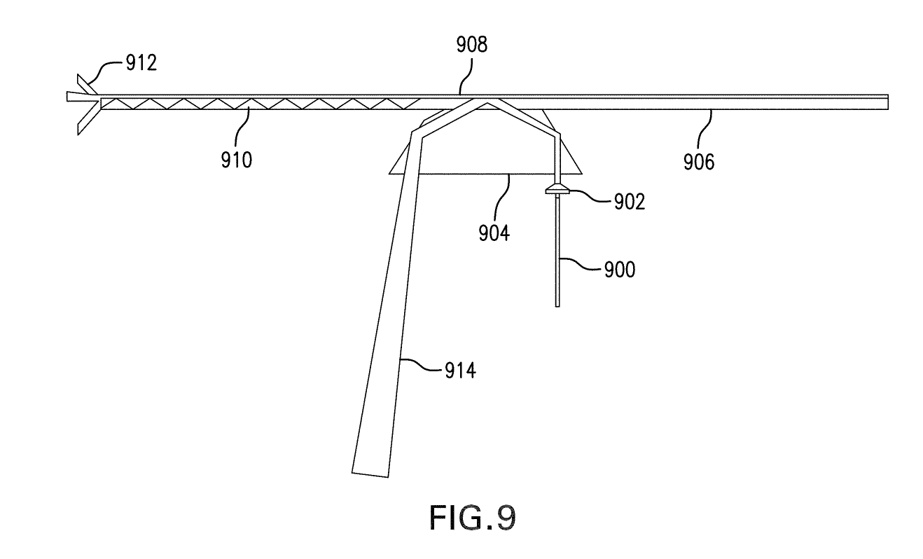

FIG. 9 shows a Zemax model of how light interacts with an interface between a microscope slide and a solution on its top surface in more detail. Light 900 enters a numerical-aperture-reducing lens 902 and enters the modified Dove prism 904 from below. When the light passes through the glass microscope slide 906 strikes the solution 908 overlying the top surface of the microscope slide, a portion of the light is refracted and travels along the microscope slide 910 and emerges at 912. A second portion is reflected back through the prism and emerges as light beam 914, which has a particular 2-dimensional shape. It is this beam 914 that strikes the CMOS detector array to provide an image that can be analyzed.

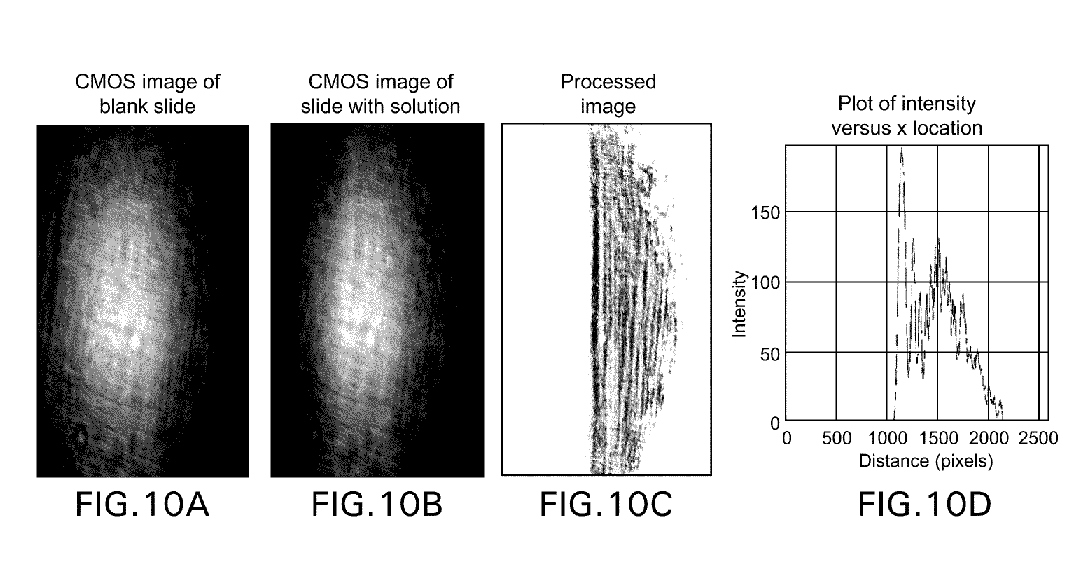

The software components of the design include the image analysis algorithm established to process an image, the graphical user interface that allows for user input to the device, and the overall programming of the hardware in python. An open source computer vision library called OpenCV was installed onto the Raspberry Pi in order to analyze the images captured by the Raspberry Pi NOIR CMOS. Every time a new microscope slide is loaded onto the device, an image of the blank slide is captured and stored. Once a buffer is placed on the microscope slide and the user selects to begin recording data, a new image is captured. In order to extract meaningful data, the blank slide image is subtracted from the image with the sample. Next, the image is converted to a binary image using an optimized threshold value. The image is then rotated to ensure that the edge of the illuminated region is vertical. Each column of the image matrix is then summed to obtain a single horizontal array. Lastly, the location of the maximum value within the array (which corresponds to location of the edge of the illuminated region) is found. A summarized depiction of the process is shown in FIG. 10.

FIG. 10A shows a CMOS image in the case where no solution overlays microscope slide and the laser light is reflected toward the CMOS detector because of the large mismatch between the refractive index of the microscope slide and air. When a solution is placed onto the microscope slide, the image is changed because a smaller mismatch between the refractive index of the solution and the microscope slide exists, leading to an image of the type shown in FIG. 10B. The image is process to enhance the edge of the image as shown in FIG. 10C and reflected in the intensity plot shown in FIG. 10D. The position of the edge can be seen to move as was shown in the bottom portion of FIG. 8.

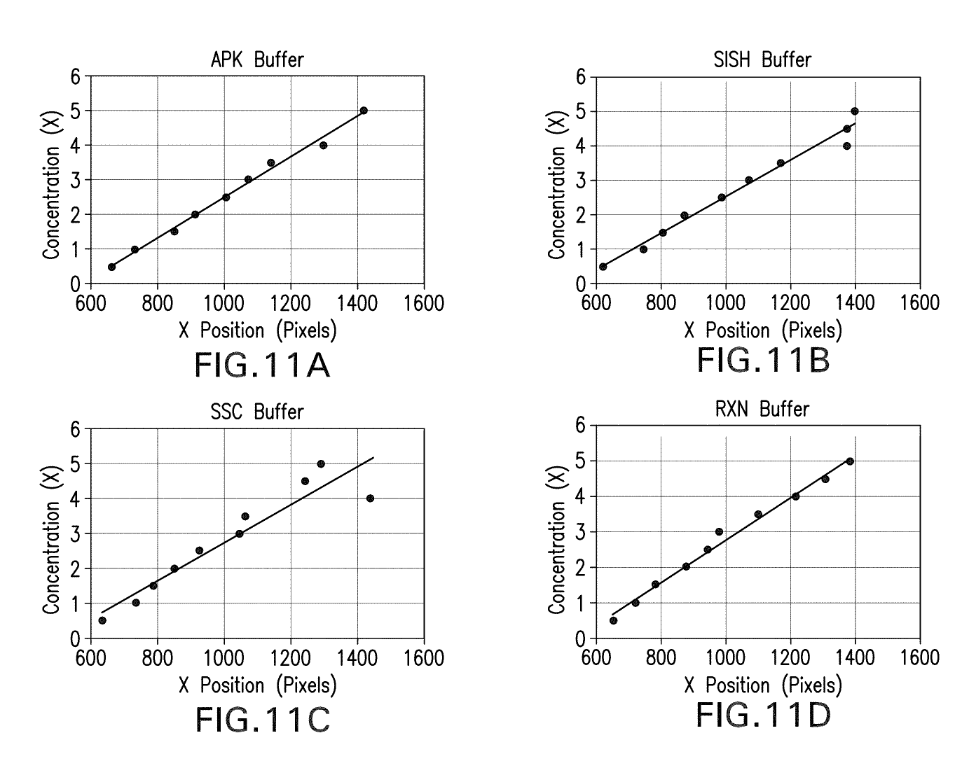

Models relating the output of the image analysis (x location of the edge of the illuminated region) and the concentration were made for four different buffers: APK, SISH, SSC, and RXN (Ventana Medical Systems, Inc., Tucson). To create these models, serial dilutions of 10× stock buffer were made in the required concentration range of 0.5× to 5×. The device described above was set up using 7 μL of index matching oil and a clean microscope slide for each buffer type. Buffer with a known concentration was added with a volume of 100 μL to the slide and the concentration was determined. The output was plotted against the concentration which resulted in a linear trend for each buffer type as seen in FIG. 11, wherein FIG. 11A shows the plot for APK buffer, FIG. 11B shows the plot for SISH buffer, FIG. 11C shows the plot for SSC buffer, and FIG. 11D shows the plot for RXN buffer. The best fit equations resulting from these plots, as well as the Model R² values for each buffer type, are displayed in Table 1 below.

TABLE 1
Best fit equations and corresponding R² value for the various buffer types

| Buffer Type | Best Fit Equation | Model R² |
|---|---|---|
| APK | C = 0.005831x − 3.3391 | 0.9932 |
| SISH | C = 0.005291x − 2.7582 | 0.9775 |
| SSC | C = 0.005427x − 2.6892 | 0.8889 |
| RXN | C = 0.006009x − 3.2279 | 0.9896 |

Accuracy of measurement using the device was determined by measuring five different random concentrations (within the required range) of each buffer. The outputted value by the device was then compared to the actual concentration value by calculating the percent error. On average, it was seen that the device was able to output a concentration reading with error less than 10% for the SISH buffer (7.11% error) and the RXN buffer (7.99% error).

In simulations, volume of the solution was shown to not be a factor in the output of the refractometer, rather only complete coverage of the prism area where electromagnetic radiation impinged on the fluid. All curves were generated with a volume of 100 μL on the slide. To ensure that the device can measure the concentration of the solution within the required volume range (200 μL-2 mL), 2 mL of 1×RXN Buffer was measured using the device.

Tests concerning accuracy, volume, and concentration range were conducted with solutions at a fixed temperature of 27 degrees Celsius. This is appropriate for general purposes, as most measurements will be taken at room temperature. However, buffer solutions may be applied at various temperatures, so measurements should be taken with solutions at temperatures ranging from 20 to 90 degrees Celsius. To address this, the relationship of concentration of RXN buffer, x-position on the processed image, and temperature was determined with the device. A table of x-position values determined from the images at concentrations ranging from 0.5× to 5× of the RXN buffer at temperatures of 4, 24, 60 and 90 degrees Celsius showed that solutions with varying temperature within the range of 4 to 90 degrees Celsius could be measured with the device. From this data, an equation for the concentration was determined, as a function of both temperature and the x-location of the reflected light, as shown in equation 2 below.

[C](T,x)=0.0039T+0.0052x−2.7307 Equation 2:

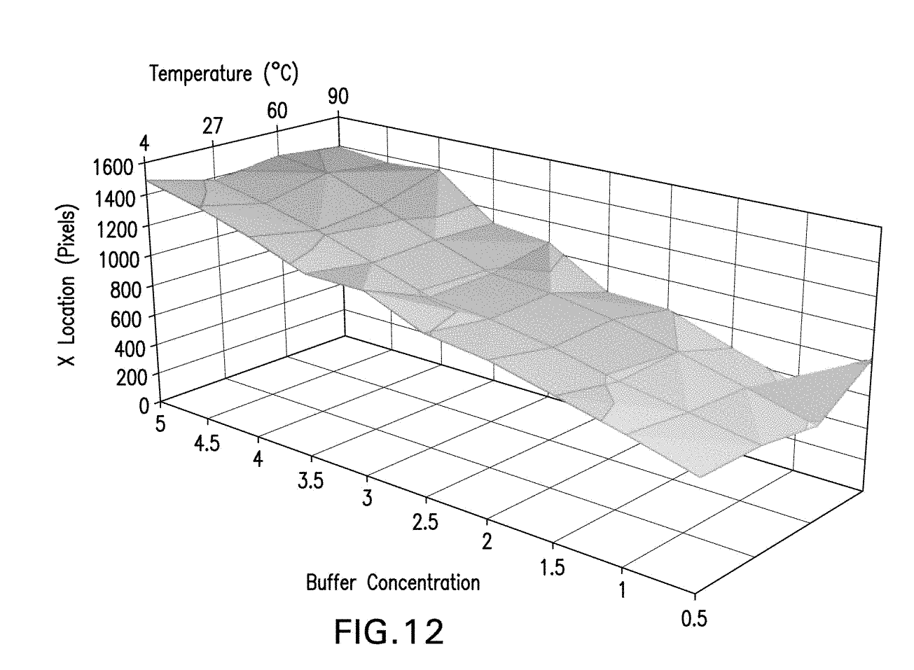

This planar equation is created using the temperature range (20 to 90 degrees Celsius) and therefore shows the device is capable of measuring solutions with temperatures in this range. The plot of the measured data also shows that this is a relatively consistent planar trend, and supports the accuracy of the model. A plot of the data from this experiment is seen in FIG. 12.

In order to determine an approximate the sampling rate of the device, the max theoretical evaporation rate was calculated using equation 3.

$${g}_{s} = \frac{θ A ( {x}_{s} - x )}{3600} = water evaperated ( kg \text{/} s ) \\ θ = ( 25 + 19 v ) = evaporation coefficient ( kg \text{/} {m}^{2} h ) \\ A = water surface area ( {m}^{2} ) \\ {x}_{s} = humidity ration in saturated air ( kg / kg ) \\ x = humidity ratio in air ( kg / kg ) \qquad Equation 3$$

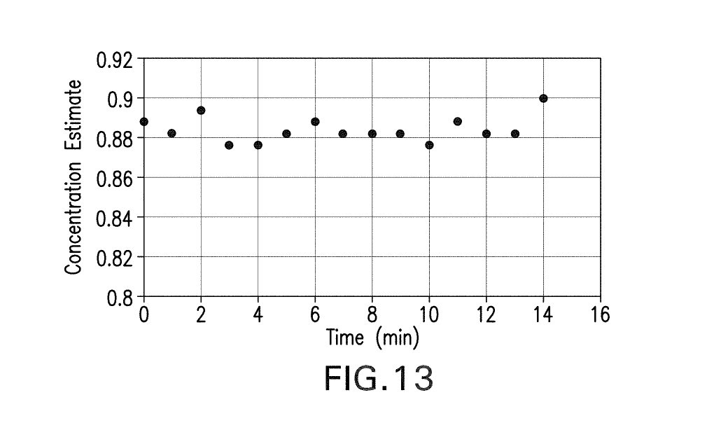

In order to help ensure that the approximation is valid, assumptions were made in order to maximize the possible evaporation rate. The surface area of the solution was set to the maximum slide area and constants for pure water were used as salt water has a slower evaporation rate, and the salt content of buffers can vary. The velocity of air above the surface was also assumed to be equal to zero, as the device has a lid. The minimum initial volume was also assumed to be 200 μL, therefore a 10% concentration change occurs with as little as 18 μL loss. With these assumptions, it is estimated that a 10% change in concentration will occur in 187 seconds (3.1 min). This means that the device should sample at least once every 3.1 min, however, more frequent or less frequent sampling rates would be appropriate for more or less volatile fluids. The actual sampling rate performance of the device was tested by adding 1 mL of 1×RXN Buffer to the slide, then measuring the concentration every minute. A plot of these results is seen in FIG. 13. Results from this experiment show the device can sample faster than a 10% change in concentration of the solution, even at a rate much slower than the device is maximally capable.

In other embodiments, the system described above can be incorporated as one or more subsystems into an automated slide staining system that robotically applies fluids to microscope slide mounted biological samples. Automated systems employ a computer to control the sample treatment process, monitor sensors, and perhaps control movement of samples and reagents within the system. Examples of automated slide staining systems into which the disclosed system for monitoring on-slide concentrations in real time can be included as an additional subsystem for stain process monitoring are disclosed in, for example, U.S. Pat. Nos. 6,352,861, 6,783,733, 7,476,543, 7,901,941, 8,454,908, 8,877,485, 8,883,509 and 8,932,543, the contents of which are each incorporated by reference herein.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. Examples of input devices include a keyboard, a cursor control devices (e.g., a mouse), a microphone, a scanner, and so forth. Examples of output devices include a display device (e.g., a monitor or projector), speakers, a printer, a network card, and so forth. Display devices may include display devices that provide visual information, this information typically may be logically and/or physically organized as an array of pixels. An interface controller may also be included that may comprise any of a variety of known or future software programs for providing input and output interfaces. For example, interfaces may include what are generally referred to as “Graphical User Interfaces” (often referred to as GUI's) that provides one or more graphical representations to a user. Interfaces are typically enabled to accept user inputs using means of selection or input known to those of ordinary skill in the related art. The interface may also be a touch screen device. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft Windows Powershell that employs object-oriented type programming architectures such as the Microsoft .NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation, a SPARC processor made by Sun Microsystems, an Athlon, Sempron, Phenom, or Opteron processor made by AMD Corporation, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation; the Mac OS X operating system from Apple Computer Corp.; a Unix or Linux-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

System memory may include any of a variety of known or future memory storage devices that can be used to store the desired information and that can be accessed by a computer. Computer readable storage media may include volatile and non-volatile, removable and non-removable media implemented in any method or technology for storage of information such as computer readable instructions, data structures, program modules, or other data. Examples include any commonly available random access memory (RAM), read-only memory (ROM), electronically erasable programmable read-only memory (EEPROM), digital versatile disks (DVD), magnetic medium, such as a resident hard disk or tape, an optical medium such as a read and write compact disc, or other memory storage device. Memory storage devices may include any of a variety of known or future devices, including a compact disk drive, a tape drive, a removable hard disk drive, USB or flash drive, or a diskette drive. Such types of memory storage devices typically read from, and/or write to, a program storage medium such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with memory storage device. In some embodiments, a computer program product is described comprising a computer usable medium having control logic (computer software program, including program code) stored therein. The control logic, when executed by a processor, causes the processor to perform functions described herein. In other embodiments, some functions are implemented primarily in hardware using, for example, a hardware state machine. Implementation of the hardware state machine so as to perform the functions described herein will be apparent to those skilled in the relevant arts. Input-output controllers could include any of a variety of known devices for accepting and processing information from a user, whether a human or a machine, whether local or remote. Such devices include, for example, modem cards, wireless cards, network interface cards, sound cards, or other types of controllers for any of a variety of known input devices. Output controllers could include controllers for any of a variety of known display devices for presenting information to a user, whether a human or a machine, whether local or remote. In the presently described embodiment, the functional elements of a computer communicate with each other via a system bus. Some embodiments of a computer may communicate with some functional elements using network or other types of remote communications. As will be evident to those skilled in the relevant art, an instrument control and/or a data processing application, if implemented in software, may be loaded into and executed from system memory and/or a memory storage device. All or portions of the instrument control and/or data processing applications may also reside in a read-only memory or similar device of the memory storage device, such devices not requiring that the instrument control and/or data processing applications first be loaded through input-output controllers. It will be understood by those skilled in the relevant art that the instrument control and/or data processing applications, or portions of it, may be loaded by a processor, in a known manner into system memory, or cache memory, or both, as advantageous for execution. Also, a computer may include one or more library files, experiment data files, and an internet client stored in system memory. For example, experiment data could include data related to one or more experiments or assays, such as detected signal values, or other values associated with one or more sequencing by synthesis (SBS) experiments or processes. Additionally, an internet client may include an application enabled to access a remote service on another computer using a network and may for instance comprise what are generally referred to as “Web Browsers”. In the present example, some commonly employed web browsers include Microsoft Internet Explorer available from Microsoft Corporation, Mozilla Firefox from the Mozilla Corporation, Safari from Apple Computer Corp., Google Chrome from the Google Corporation, or other type of web browser currently known in the art or to be developed in the future. Also, in the same or other embodiments an Internet client may include, or could be an element of, specialized software applications enabled to access remote information via a network such as a data processing application for biological applications.

A network may include one or more of the many various types of networks well known to those of ordinary skill in the art. For example, a network may include a local or wide area network that may employ what is commonly referred to as a TCP/IP protocol suite to communicate. A network may include a network comprising a worldwide system of interconnected computer networks that is commonly referred to as the Internet, or could also include various intranet architectures. Those of ordinary skill in the related arts will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

As used herein the term “about” refers to ±10%.

The terms “comprises”, “comprising”, “includes”, “including”, “having” and their conjugates mean “including but not limited to”. This term encompasses the terms “consisting of” and “consisting essentially of”. The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is to be appreciated that certain features of the disclosed system and method, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

Although the invention has been described in conjunction with specific embodiments thereof, many alternatives, modifications and variations will be apparent to those skilled in the art. Accordingly, it is intended to embrace all such alternatives, modifications and variations that fall within the spirit and scope of the following claims.

1. A system for monitoring treatment of a biological sample with a fluid, wherein the biological sample is mounted on a surface of a substrate, the system comprising:
a. a source of electromagnetic radiation;
b. at least one prism positioned to receive the electromagnetic radiation from the source and direct the electromagnetic radiation to a first surface of the substrate, wherein the first surface is opposite a second surface of the substrate, wherein the biological sample is mounted on the second surface and the fluid overlays at least a portion of the biological sample mounted on the second surface, and wherein the electromagnetic radiation further passes through the substrate, to an interface between the substrate and the fluid;
c. a detector positioned to detect electromagnetic radiation reflected from the interface between the substrate and the fluid, back through the substrate, and through the prism, wherein a change in a characteristic of the electromagnetic radiation reflected from the interface between the substrate and the fluid and impinging on the detector indicates a change in a concentration of a component of the fluid; and,
d. a processor that receives a signal from the detector and converts the signal into a measure of the concentration of the component of the fluid.

2. The system of claim 1, wherein the source of electromagnetic radiation comprises a laser source of radiation.

3. The system of claim 1, further comprising a focusing lens positioned between the source of electromagnetic radiation and the prism.

4. The system of claim 1, wherein the prism comprises a modified dove prism configured to impinge the electromagnetic radiation onto the interface between the substrate and the fluid at an angle such that at least a portion of the electromagnetic radiation is reflected by total internal reflection from the interface between the substrate and the fluid back through the prism toward the detector.

5. The system of claim 1, wherein the detector comprises a detector array.

6. The system of claim 5, wherein the detector array comprises a CMOS array.

7. The system of claim 5, wherein the characteristic of the electromagnetic radiation reflected from the interface between the substrate and the fluid is a 2-dimensional shape of the electromagnetic radiation reflected from the interface between the substrate and the fluid and impinging on the detector array.

8. The system of claim 1, further comprising a liquid temperature sensor for monitoring the temperature of at least a portion of the fluid.

9. The system of claim 8, wherein the liquid temperature sensor comprises a thermocouple in contact with the fluid and/or the prism.

10. The system of claim 8, wherein the liquid temperature sensor comprises an infrared liquid temperature sensor positioned to measure a temperature of the fluid and/or the prism.

11. The system of claim 1, wherein the prism is optically connected to the source of electromagnetic radiation by at least one first electromagnetic wave guide leading from the source of electromagnetic radiation toward a surface of the prism.

12. The system of claim 1, wherein the prism is optically connected to the detector by at least one second electromagnetic wave guide leading from the prism to the detector.

13. The system of claim 11, wherein the first and second electromagnetic wave guides each comprise at least one optical fiber.

14. The system of claim 13, wherein the first and second electromagnetic wave guides each comprise bundles of optical fibers.

15. The system of claim 1, further comprising a prism actuator configured to move the prism relative to the first surface of the substrate to direct the electromagnetic radiation at least partially toward a different portion of the interface between the substrate and the fluid or to impinge the electromagnetic radiation on the first surface of the substrate at a different angle.

16. The system of claim 1, further comprising a feedback module configured to detect changes to the fluid and cause the system to adjust the composition of the fluid by causing a dispenser to dispense a second amount of the same, or a different, fluid onto the substrate in response to a detected change in the concentration of the component of the fluid.

17. The system of claim 1, wherein the characteristic comprises one or more of, in any combination, of the amount of the electromagnetic radiation that is reflected from the interface between the substrate and the fluid, a pattern of the electromagnetic radiation reflected from the interface between the substrate and the fluid, a position of the electromagnetic radiation reflected from the interface between the substrate and the fluid, and the polarization of the electromagnetic radiation that is reflected from the interface between the substrate and the fluid.

18. The system of claim 1, wherein the electromagnetic radiation comprises near IR radiation having a wavelength between about 700 nm and about 1100 nm.

19. The system of claim 1, wherein the electromagnetic radiation comprises visible radiation having a wavelength between about 400 nm and about 700 nm.

20. The system of claim 2, wherein the source of electromagnetic radiation comprises an LED laser.

21. The system of claim 1, further comprising a substrate holder, wherein the substrate holder is either at least partially optically transparent to the electromagnetic radiation or supports the substrate by at least one outer edge of the substrate.

22. The system of claim 1, wherein the fluid comprises at least one of a buffer, a dye, and a specific-binding molecule.

23. The system of claim 22, wherein the specific-binding molecule comprises at least one of a nucleic acid, a nucleic acid analog, an antibody, an antibody fragment, and an aptamer.

24. The system of claim 1, further comprising a refractive index matching substance positioned between the prism and the first surface of the substrate.

25. A method for monitoring a staining process of a biological sample taking place on a substrate, the method comprising:
a. passing electromagnetic radiation through a prism to a first surface of the substrate, wherein the first surface is opposite a second surface of the substrate, wherein the biological sample is mounted on the second surface and a fluid overlays at least a portion of the biological sample mounted on the second surface, and wherein the electromagnetic radiation passes through the substrate and to an interface between the substrate and the fluid, wherein at least a portion of the electromagnetic radiation is reflected from the interface between the substrate and the fluid back through the substrate, back through the prism, and onto a detector;
b. measuring a characteristic of the electromagnetic radiation reflected from the interface between the substrate and the fluid, back through the substrate, back through the prism, and onto the detector,
wherein the characteristic of the electromagnetic radiation comprises a characteristic influenced by a composition of the fluid.

26. The method of claim 25, further comprising calculating a composition of the fluid from the measured characteristic.

27. The method of claim 25, wherein the characteristic influenced by the composition of the fluid comprises a characteristic influenced by a refractive index of the fluid.

28. The method of claim 25, further comprising compensating the measured change in the characteristic of the electromagnetic radiation for a change in temperature.

29. The method of claim 28, further comprising compensating for a composition of the substrate.

30. The method of claim 25, further comprising compensating for a starting composition of the fluid.

31. The method of claim 25, wherein the detector comprises a detector array and the measured characteristic of the electromagnetic radiation comprises a two dimensional pattern of the electromagnetic radiation reflected from the interface between the substrate and the fluid.

32. The method of claim 30, further comprising applying image analysis to sharpen a linear edge of the two dimensional image, wherein the position of the linear edge is proportional to the composition of the fluid.

33. The method of claim 25, further comprising calculating the composition over time.

34. The method of claim 25, wherein the staining process is stopped when a predetermined change in the characteristic of the electromagnetic radiation is reached or when the characteristic of the electromagnetic radiation has been maintained within a predetermined range for a predetermined length of time.

35. The method of claim 25, further comprising adjusting the composition of the fluid in response to a change in the characteristic of the electromagnetic radiation reflected from the interface between the substrate and the fluid.

36. The method of claim 35, wherein adjusting the composition of the fluid comprises applying an additional amount of the fluid to the second surface of the substrate on which the biological sample is mounted.

37. The method of claim 35, wherein adjusting the composition of the fluid comprises applying an additional amount of a solvent of the fluid to compensate for solvent lost due to evaporation.

38. A system for treatment of a biological sample mounted on a substrate with a first fluid, the system comprising:
a. at least one substrate holder;
b. at least one source of electromagnetic radiation;
c. at least one prism positioned to receive the electromagnetic radiation from the source and direct the electromagnetic radiation to a first surface of the substrate, wherein the first surface is opposite a second surface of the substrate, wherein the biological sample is mounted on the second surface and the fluid overlays at least a portion of the biological sample mounted on the second surface, and wherein the electromagnetic radiation further passes through the substrate, to an interface between the substrate and the fluid; and,
d. a detector positioned to detect electromagnetic radiation reflected from the interface between the substrate and the fluid, back through the substrate, and through the prism, wherein a change in a characteristic of the electromagnetic radiation reflected from the interface between the substrate and the fluid and impinging on the detector indicates a change in a concentration of a component of the fluid;
e. at least one automated fluid dispenser configured to deliver the first fluid or a second fluid to the second surface of the substrate; and,
f. a processor that receives a signal from the detector and converts the signal into a measure of the concentration of the component of the fluid, and if the measure of the concentration of the component has changed more than a predetermined amount from an initial concentration, the processor directs the automated fluid dispenser to dispense either or both of the first and/or second fluid to the second surface of the substrate where the biological sample is mounted.

39. The system of claim 38, wherein the at least one substrate comprises a glass microscope slide.

40. The system of claim 38, wherein the at least one prism comprises a modified dove prism.

41. The method of claim 38, wherein the at least one source of electromagnetic radiation comprises a fiber-coupled laser diode operating in the near infrared portion of the electromagnetic spectrum.

42. The system of claim 38, wherein the characteristic of the electromagnetic radiation comprises a 2-dimensional pattern of the electromagnetic radiation reflected from the interface between the substrate and the fluid, and the detector comprises a CMOS array detector, and wherein the processor is further configured to analyze the image of the 2-dimensional pattern of the electromagnetic radiation reflected from the interface between the substrate and sharpen a linear edge of the two dimensional image, wherein the position of the linear edge is proportional to the concentration of a component of the fluid.
